(19) United States
(12) Patent Application Publication
(10) Pub. No.: US 2021/0394164 A1
(43) Pub. Date: Dec. 23, 2021

(54) MILLIMETER-SCALE PEROXYMONOSULFATE ACTIVATOR ZSM-5-(C@Fe) AND PREPARATION METHOD AND APPLICATION THEREOF

(71) Applicants: SOUTH CHINA UNIVERSITY OF TECHNOLOGY, Guangdong (CN); GUANDONG YIDING ENVIRONMENTAL PROTECTION ENGINEERING CO., LTD., Guangdong (CN)

(72) Inventors: Jinquan WAN, Guangdong (CN); Yan WANG, Guangdong (CN); Haiyuan CHI, Guangdong (CN); Quanmo XIE, Guangdong (CN); Yongwen MA, Guangdong (CN)

(73) Assignees: SOUTH CHINA UNIVERSITY OF TECHNOLOGY, Guangdong (CN); GUANDONG YIDING ENVIRONMENTAL PROTECTION ENGINEERING CO., LTD., Guangdong (CN)

(21) Appl. No.: 17/160,381

(22) Filed: Jan. 28, 2021

(30) Foreign Application Priority Data
Jun. 23, 2020 (CN) 202010579105.2

(51) Int. Cl. B01J 29/46; B01J 37/08; B01J 37/04; B01J 35/02; B01J 37/03; B01J 37/00

(52) U.S. Cl. CPC B01J 29/46; B01J 37/082; B01J 37/009; B01J 35/023; B01J 37/031; B01J 37/04

(57) ABSTRACT

A millimeter-scale peroxymonosulfate activator ZSM-5-(C@Fe) and a preparation method and an application thereof are provided. According to the method, a PMS activator ZSM-5-(C@Fe) with a millimeter-scale stable structure is synthesized in the following steps: (1) preprocessing a ZSM-5 by a carboxylation method to obtain a ZSM-5-COOH; (2) synthesizing a ferrous metal organic framework material by a thermal method to obtain a precursor Fe (II)-MOF-74; (3) dispersing the ZSM-5-COOH in the step (1) and an ethyldiol methacrylate in an acetonitrile, and mixing evenly to obtain a mixed solution; and adding the precursor Fe(II)-MOF-74 in the step (2) into the mixed solution, carrying out a stirring reaction under an action of an initiator, filtering to obtain a precipitate, washing, and drying in vacuum to obtain ZSM-5-MOFs; and (4) in a nitrogen atmosphere, heating the ZSM-5-MOFs in the step (3) to carry out high-temperature pyrolysis to obtain the millimeter-scale peroxymonosulfate activator ZSM-5-(C@Fe).

### CROSS-REFERENCE TO RELATED APPLICATION

This application claims the priority benefit of China application serial no. 202010579105.2, filed on Jun. 23, 2020. The entirety of the above-mentioned patent application is hereby incorporated by reference herein and made a part of this specification.

### TECHNICAL FIELD

The present invention belongs to the technical field of water pollution control, and more particularly, relates to a preparation method of a millimeter-scale peroxymonosulfate activator ZSM-5-(C@Fe) and a method for degrading emerging contaminants.

### BACKGROUND

Emerging contaminants (ECs) generally refer to a kind of organic contaminants that have no emission standards, but are taken as objects to be controlled due to potential hazards thereof. In recent years, with wide applications of pesticides, antibiotics, and cosmetics, the ECs in surface water have increased significantly, thus posing a great threat to an aquatic environment. However, a biological treatment process cannot effectively remove the ECs from wastewater due to a stable chemical structure and a bioaccumulation property of the ECs. Therefore, an advanced oxidation technology serving as an effective tertiary wastewater treatment technology has attracted people's attention.

With development of research, activation of a peroxymonosulfate (PMS) with a carbon-based heterogeneous catalyst can not only generate a free radical degradation pathway based on a sulfate radical (SO₄⁻), but also generate a non-free-radical degradation pathway based on singlet oxygen (¹O₂), so that the ECs in the wastewater may be degraded at a high speed. In a traditional method, doping of elements (Fe, N, S) of carbon-based materials is often a main method to improve an activity of the heterogeneous catalyst, and a catalyst formed by doping of non-metallic elements is easy to cause side reactions during oxidative degradation (W. Tian, H. Zhang, X. Duan, H. Sun, M. O. Tade, H.M. Ang, S. Wang, Nitrogen- and Sulfur-Codoped Hierarchically Porous Carbon for Adsorptive and Oxidative Removal of Pharmaceutical Contaminants, Appl. Mater. Interfaces, (2016), 8, 7184-7193. doi: 10.1021/acsami.6b01748.), while most of existing doping methods of Fe are an impregnation method, and the Fe doped by the method is easy to fall off (M. Pagano, A. Volpe, G. Mascolo, A. Lopez, V. Locaputo, R. Ciannarella, Chemosphere Peroxymonosulfate—Co (II) oxidation system for the removal of the non-ionic surfactant Brij 35 from aqueous solution, Chemosphere. 86 (2012) 329-334. doi: 10.1016/j.chemosphere.2011.09.010.). Therefore, a current technology is easy to cause deactivation of the catalyst, thus restricting recycling of the catalyst. In addition, existing heterogeneous catalysts are all nano-scale materials, and are easy to be lost in a water treatment process, whether a fluidized bed structure is formed or a special reactor is manufactured, resulting in waste of the catalysts (G. Ye, Z. Yu, Y. Li, L. Li, L. Song, L. Gu, X. Cao, Efficient treatment of brine wastewater through a flow-through technology integrating desalination and photocatalysis, Water Research, 157 (2019) 134-144. doi:10.1016/j.watres.2019.03.058.). Therefore, it is very important to synthesize a stable millimeter-scale PMS activator for industrial promotion of a PMS advanced oxidation system.

### SUMMARY

Aiming at an instability of an element doping method of traditional carbon-based materials, which are mostly nano materials, and deactivation of a catalyst caused by easily occurred side reactions, falling off, and other phenomena, an objective of the present invention is to provide a preparation method of a millimeter-scale PMS activator ZSM-5-(C@Fe) and a method for degrading emerging contaminants.

According to the preparation method provided by the present invention, the millimeter-scale PMS activator ZSM-5-(C@Fe) is successfully synthesized for the first time, and a good degradation effect is obtained in an experiment of efficiently degrading the emerging contaminants by activating a PMS.

The objective of the present invention is achieved by at least one of the following technical solutions.

The present invention provides a preparation method of a millimeter-scale PMS activator ZSM-5-(C@Fe), which includes the following steps:

(1) preprocessing the ZSM-5 by a carboxylation method to obtain a ZSM-5-COOH;

(2) synthesizing a ferrous metal organic framework material by a thermal method to obtain a precursor Fe (II)-MOF-74;

(3) dispersing the ZSM-5-COOH in the step (1) and an ethyldiol methacrylate in an acetonitrile, and mixing evenly to obtain a mixed solution; and adding the precursor Fe(II)-MOF-74 in the step (2) into the mixed solution, carrying out a stirring reaction under an action of an initiator, filtering to obtain a precipitate, the precipitate being granular, washing, and drying in vacuum in a vacuum furnace to obtain ZSM-5-MOFs (white precursors); and (4) in a nitrogen atmosphere, heating the ZSM-5-MOFs in the step (3) to carry out high-temperature pyrolysis to obtain the millimeter-scale PMS activator ZSM-5-(C@Fe).

Further, a mass ratio of the ZSM-5-COOH to the precursor Fe(II)-MOF-74 in the step (3) is 10:1 to 10:2.

Further, according to the preparation method of the millimeter-scale PMS activator ZSM-5-(C@Fe), a mass-volume ratio of the ZSM-ZSM-5-COOH to the acetonitrile in the step (3) is (5 to 15):100 g/mL.

Further, a molar volume ratio of the ethyldiol methacrylate to the acetonitrile in the step (3) is (25 to 75):100 mmol/mL.

Further, the stirring reaction in the step (3) is carried out at 40° C. to 80° C. for 20 hours to 28 hours.

Further, the initiator in the step (3) is azobisisobutyronitrile.

Preferably, the initiator in the step (3) has an adding amount of 10 mg to 20 mg.

Preferably, the washing in the step (3) is carried out with methanol.

Further, the drying in vacuum in the step (3) is carried out at 50° C. to 80° C. for 10 hours to 12 hours.

Further, the high-temperature pyrolysis in the step (4) is carried out at 400° C. to 600° C. for 1 hour to 3 hours.

The present invention provides a millimeter-scale PMS activator ZSM-5-(C@Fe) prepared by the above preparation method. The millimeter-scale PMS activator ZSM-5-(C@Fe) obtained by the present invention is a millimeter-scale black solid sphere with a diameter of 1 mm to 5 mm.

An application of the millimeter-scale PMS activator ZSM-5-(C@Fe) provided by the present invention in treating ECs in wastewater includes the following steps:

adding the millimeter-scale PMS activator ZSM-5-(C@Fe) and the PMS into the wastewater containing the ECs, and then performing a catalytic activation reaction (at a room temperature) in a shaking table to obtain the treated wastewater.

In the application of the millimeter-scale PMS activator ZSM-5-(C@Fe) provided by the present invention in treating the ECs in the wastewater, a molar ratio of the PMS to the ECs in the wastewater is 10:1 to 50:1; the millimeter PMS activator ZSM-5-(C@Fe) has an adding amount of 1 g·L⁻¹ to 5 g·L⁻¹; the ECs are more than one of tetrabromobisphenol A, sulfamethoxazole, trichlorophenol, and ciprofloxacin; the shaking table has a rotating speed of 50 rpm to 200 rpm, and the catalytic activation reaction lasts for 10 minutes to 30 minutes.

Preferably, the catalytic activation reaction lasts for 15 minutes.

Preferably, the ZSM-5-(C@Fe) has an adding amount of 4 g·L⁻¹.

Preferably, a molar ratio of the PMS to the ECs in the wastewater is 40:1.

In the application of the millimeter-scale PMS activator ZSM-5-(C@Fe) provided by the present invention in treating the ECs in the wastewater, the activation site on the ZSM-5-(C@Fe) is utilized to activate the PMS, and a sulfate anion radical with a strong oxidizing property and singlet oxygen are generated at a room temperature to degrade the emerging contaminants in the wastewater.

The ZSM-5-(C@Fe) provided by the present invention has an excellent activation ability to remove the ECs in water, and the ZSM-5-(C@Fe) has a stable structure, is easy to be recovered, and may be recycled for many times.

In the present invention, a novel millimeter-scale PMS activator ZSM-5-(C@Fe) with a Fe-doped C structure which has an excellent water stability of the ZSM-5 and an activation site formed by pyrolysis of MOFs is formed by utilizing a characteristic that the ZSM-5 is easy to be carboxylated and free carboxyl polymerization in the metal-organic framework materials (MOFs), and then subjected to pyrolysis in a nitrogen atmosphere. The ZSM-5-(C@Fe) may exist stably in a water treatment process, and is not easy to run off, and after repeated use, an activation effect is still very good. An activated stable point formed by Fe-doped C may generate both a free radical degradation pathway based on a sulfate anion radical and a non-free-radical degradation pathway based on singlet oxygen, so that an activation efficiency and a degradation rate of the emerging contaminants are improved.

In the present invention, the millimeter-scale PMS activator ZSM-5-(C@Fe) is synthesized for the first time by utilizing an excellent water stability and an easy carboxylation characteristic of the ZSM-5 and a characteristic that stable Fe-doped C materials may be formed by pyrolysis of the metal-organic framework materials (MOFs), the catalyst has a C@Fe structure capable of efficiently activating the site, and also has a ZSM-5 structure with a high water stability structure, so that continuous recycling can be realized while efficiently degrading the emerging contaminants, thus providing a wide application prospect for treating persistent organic contaminants.

Compared with the prior art, the present invention has the following advantages and beneficial effects:

(1) the present invention provides the preparation method of the millimeter-scale PMS activator ZSM-5-(C@Fe) synthesized for the first time;

(2) the millimeter-scale PMS activator ZSM-5-(C@Fe) provided by the present invention has a good water stability, and is easy to be recovered for recycling;

(3) the millimeter-scale PMS activator ZSM-5-(C@Fe) provided by the present invention enhances an activation ability of the PMS, and accelerates the removal rate of the emerging contaminants;

(4) the millimeter-scale PMS activator ZSM-5-(C@Fe) provided by the present invention has no selectivity to target contaminants, and has a wide applicability; and

(5) the millimeter-scale PMS activator ZSM-5-(C@Fe) provided by the present invention is applied in a method of catalytically activating the PMS to treat the ECs without additional accessory energy, so that a cost is reduced; and moreover, a process flow is very simple, an effect is good, and time is short, thus having a broad practical application prospect.

### BRIEF DESCRIPTION OF THE DRAWINGS

FIG. 1 is an X-ray crystallogram (XRD) of a ZSM-5-(C@Fe) in the Embodiment 1; and

FIG. 2 is a scanning electron micrograph (SEM) of the ZSM-5-(C@Fe) in the Embodiment 1.

### DETAILED DESCRIPTION

The specific implementation of the present invention is further described with reference to the embodiments, but the implementation and the protection of the present invention are not limited hereto. It should be noted that if there is any process that is not specifically described in detail hereinafter, it may be realized or understood by those skilled in the art with reference to the prior art. If the manufacturer of the reagent or the instrument used is not indicated, the reagent or the instrument is regarded as a conventional product capable of being purchased from the market.

### Embodiment 1

In the embodiment, a ZSM-5-(C@Fe) prepared with a good ability to degrade emerging contaminants was investigated.

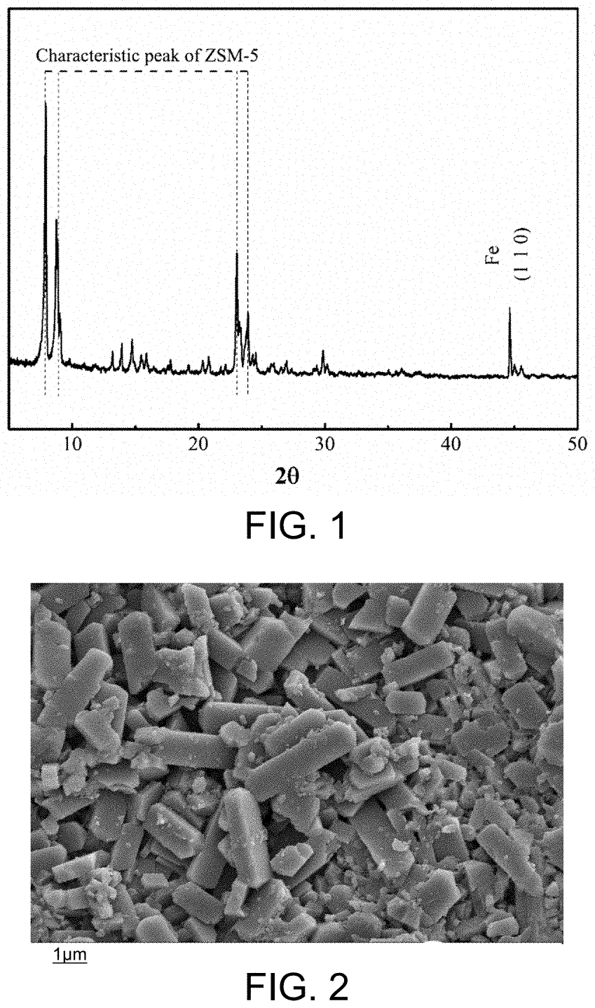

(1) Preparation of the ZSM-5-(C@Fe): 10 g of ZSM-5, 150 mmol of 3-aminopropyltriethoxysilane, and 150 mmol of maleic anhydride were evenly dispersed in 100 mL of N,N-dimethylformamide, and stirred at a room temperature for 24 hours; and then, a granular sample was washed with methanol, and dried at 50° C. for 12 hours to obtain a precursor ZSM-5-COOH. Terephthalic acid (1.065 g) and FeCl₂.4H₂O (2.65 g) were put into a 500 ml three-necked bottle, 250 ml of N, N-dimethylformamide was added to dissolve the mixture, then 30 ml of methanol was added, and 8 ml of hydrofluoric acid was dropwise added to enable a solution to be pale green, then heated to 140° C., and reacted for 24 hours to obtain a ferrous MOFs precursor (Fe(II)-MOF-74). 10 g of ZSM-5-COOH and 50 mmol of ethyldiol methacrylate were dispersed in 100 mL of acetonitrile to obtain a mixed solution. Then, 1 g of Fe(II)-MOF-74 and 20 mg of azobisisobutyronitrile were put into the mixed solution, and stirred at 60° C. for 24 hours. The granular sample was filtered out, washed with methanol, and then dried in a vacuum furnace at 50° C. for 12 hours to obtain white precursors ZSM-5-MOFs. Then, the ZSM-5-MOFs were subjected to high-temperature pyrolysis in a tube furnace at 500° C. for 2 hours in a nitrogen atmosphere, and the millimeter-scale PMS activator ZSM-5-(C@Fe) was finally obtained. FIG. 1 is an X-ray crystallogram (XRD) of the ZSM-5-(C@Fe) in the Embodiment 1, and the ZSM-5-(C@Fe) is found to have characteristic peaks of two crystals of ZSM-5 and Fe. FIG. 2 is a scanning electron micrograph (SEM) of the ZSM-5-(C@Fe) in the Embodiment 1, and a surface of a millimeter sphere of the ZSM-5-(C@Fe) is found to be distributed with micron-scale rod structures.

(2) A ciprofloxacin solution with a concentration of 0.036 mmol·L⁻¹ was prepared as ECs for later use.

(3) A conical flask was used as a reactor, 100 mL of ciprofloxacin solution (with a concentration of 0.036 mol·L⁻¹), 0.036 mmol of PMS, and 0.05 g of ZSM-5 were respectively added into a reactor 1, and the reactor was put into a shaking table at 180 rpm for a degradation reaction at a room temperature (25° C.).

(4) 0.1 g of ZSM-5-COOH was added into a reactor 2, without adding the ZSM-5, and other conditions were the same as those in the step (3).

(5) 0.1 g of ZSM-5-MOFs were added into a reactor 3, without adding the ZSM-5, and other conditions were the same as those in the step (3).

(6) 0.1 g of ZSM-5-(C@Fe) was added into a reactor 4, without adding the ZSM-5, and other conditions were the same as those in the step (3).

Removal rates of ciprofloxacin under different catalysts are shown in Table 1.

TABLE 1

| | | Removal | Removal | Removal |
|---|---|---|---|---|
| | Removal | rate % | rate % | rate % |
| Time | rate % | (ZSM-5- | (ZSM-5- | (ZSM-5- |
| (min) | (ZSM-5) | COOH) | MOFs) | (C@Fe)) |
| 0 | 0 | 0 | 0 | 0 |
| 2 | 8.86 | 7.59 | 14.78 | 23.78 |
| 4 | 16.56 | 17.86 | 27.56 | 40.56 |
| 6 | 21.03 | 20.99 | 39.78 | 54.89 |
| 10 | 24.56 | 23.89 | 44.86 | 67.89 |
| 15 | 25.89 | 24.99 | 49.86 | 78.56 |
| 20 | 25.85 | 25.12 | 53.78 | 89.78 |
| 30 | 25.78 | 25.18 | 57.79 | 100 |

It can be seen from Table 1 that: catalytic activation of the PMS with the ZSM-5-(C@Fe) to degrade the ciprofloxacin has a significant removal effect, because an activation site in the ZSM-5-(C@Fe) may generate both a free radical degradation pathway based on a sulfate anion radical and a non-free-radical degradation pathway based on singlet oxygen, so that an activation efficiency and a degradation rate of the emerging contaminants are improved.

### Embodiment 2

In the embodiment, effects of adding amounts of a ZSM-5-(C@Fe) on catalytic activation to degrade a ciprofloxacin were compared.

(1) A preparation method of the ZSM-5-(C@Fe) was the same as the step (1) in the Embodiment 1.

(2) 0.036 mmol·L⁻¹ ciprofloxacin solution was prepared for later use.

(3) A conical flask was used as a reactor, 0.036 mmol of PMS and 100 mL of ciprofloxacin solution with a concentration of 0.036 mmol·L⁻¹ were added into a reactor 1, 0.1 g of ZSM-5-(C@Fe) was added into the reactor at the same time, the conical flask was put into a shaking table at 180 rpm for reaction at a room temperature (25° C.), and spot sampling analysis was carried out.

(4) An adding amount of the ZSM-5-(C@Fe) in a reactor 2 became 0.2 g, and other conditions were the same as those in the (3).

(5) An adding amount of the ZSM-5-(C@Fe) in a reactor 3 became 0.3 g, and other conditions were the same as those in the (3).

(6) An adding amount of the ZSM-5-(C@Fe) in a reactor 4 became 0.4 g, and other conditions were the same as those in the (3).

(7) An adding amount of the ZSM-5-(C@Fe) in a reactor 5 became 0.5 g, and other conditions were the same as those in the (3).

Removal rates of the ciprofloxacin under different adding amounts of the ZSM-5-(C@Fe) are shown in Table 2.

TABLE 2

| | Removal | Removal | Removal | Removal | Removal |
|---|---|---|---|---|---|
| Time | rate % | rate % | rate % | rate % | rate % |
| (min) | (0.1) | (0.2) | (0.3) | (0.4) | (0.5) |
| 0 | 0 | 0 | 0 | 0 | 0 |
| 2 | 29.89 | 32.31 | 33.68 | 34.22 | 36.56 |
| 4 | 50.56 | 54.78 | 56.78 | 59.11 | 61.89 |
| 6 | 66.35 | 72.56 | 75.89 | 81.53 | 82.45 |
| 10 | 82.35 | 87.56 | 90.56 | 94.78 | 94.89 |
| 15 | 91.46 | 97.56 | 100 | 100 | 100 |
| 20 | 100 | 100 | 100 | 100 | 100 |
| 30 | 100 | 100 | 100 | 100 | 100 |

It can be seen from Table 2 that: at 30 minutes, with an increasing adding amount of the ZSM-5-(C@Fe), a degradation efficiency is increased first, and then shows a steady trend when the adding amount of the catalyst reaches 0.4 g. Considering a reaction efficiency and a cost, the adding amount of the ZSM-5-(C@Fe) of 4 g·L⁻¹ is a best choice.

### Embodiment 3

In the embodiment, effects of different molar ratios of a PMS to a ciprofloxacin on a catalytic activation reaction with a ZSM-5-(C@Fe) were compared.

(1) A preparation method of the ZSM-5-(C@Fe) was the same as the step (1) in the Embodiment 1.

(2) 0.036 mmol·L⁻¹ ciprofloxacin solution was prepared for later use.

(3) A conical flask was used as a reactor, 0.036 mmol of PMS and 100 mL of ciprofloxacin solution with a concentration of 0.036 mmol·L⁻¹ were added into a reactor 1, 0.4 g of ZSM-5-(C@Fe) was added into the reactor at the same time, the conical flask was put into a shaking table at 180 rpm for reaction at a room temperature (25° C.), and spot sampling analysis was carried out.

(4) An adding amount of the PMS in a reactor 2 became 0.072 mmol, and other conditions were the same as those in the (3).

(5) An adding amount of the PMS in a reactor 3 became 0.108 mmol, and other conditions were the same as those in the (3).

(6) An adding amount of the PMS in a reactor 4 became 0.144 mmol, and other conditions were the same as those in the (3).

(7) An adding amount of the PMS in a reactor 5 became 0.180 mmol, and other conditions were the same as those in the (3).

Removal rates of the ciprofloxacin degraded by catalytically activating the PMS with the ZSM-5-(C@Fe) under different molar ratios of the PMS to the ciprofloxacin are shown in Table 3.

TABLE 3

| | Removal | Removal | Removal | Removal | Removal |
|---|---|---|---|---|---|
| Time | rate % | rate % | rate % | rate % | rate % |
| (min) | (10:1) | (20:1) | (30:1) | (40:1) | (50:1) |
| 0 | 0 | 0 | 0 | 0 | 0 |
| 2 | 26 | 30 | 32.22 | 34.22 | 35.56 |
| 4 | 54 | 54 | 56.11 | 59.11 | 60.89 |
| 6 | 75 | 77 | 79.53 | 81.53 | 81.45 |
| 10 | 89 | 92 | 92.78 | 94.78 | 94.82 |
| 15 | 98.8 | 100 | 100 | 100 | 100 |
| 20 | 100 | 100 | 100 | 100 | 100 |
| 30 | 100 | 100 | 100 | 100 | 100 |

It can be seen from table 3 that: with increase of a ratio of n PMS/n ciprofloxacin, the removal rate of the ciprofloxacin is increased first and then decreased. When the ratio exceeds 40:1 (molar ratio), the removal rate is increased slowly. Considering a reaction efficiency and a cost, n PMS/n ciprofloxacin=40:1 is a best choice.

### Embodiment 4

In the embodiment, effects of degradation of four ECs by activating a PMS with a ZSM-5-(C@Fe) were investigated.

(1) A preparation method of the ZSM-5-(C@Fe) was the same as the step (1) in the Embodiment 1.

(2) A tetrabromobisphenol A solution, a sulfamethoxazole solution, a trichlorophenol solution, and a ciprofloxacin solution with a concentration of 0.036 mmol·L⁻¹ were prepared as ECs for later use.

(3) A conical flask was used as a reactor, 0.144 mmol of PMS and 100 mL of ciprofloxacin solution with a concentration of 0.036 mmol·L⁻¹ were added into a reactor 1, 0.4 g of ZSM-5-(C@Fe) was added into the reactor at the same time, the conical flask was put into a shaking table at 180 rpm for reaction at a room temperature (25° C.), and spot sampling analysis was carried out.

(4) 100 mL of 0.036 mmol·L⁻¹ tetrabromobisphenol A solution was added into a reactor 2 without adding the ciprofloxacin solution. Other conditions were the same as those in the (3).

(5) 100 mL of 0.036 mmol·L⁻¹ sulfamethoxazole solution was added into a reactor 3 without adding the ciprofloxacin solution. Other conditions were the same as those in the (3).

(6) 100 mL of 0.036 mmol·L⁻¹ trichlorophenol solution was added into a reactor 4 without adding the ciprofloxacin solution. Other conditions were the same as those in the (3).

Effects of degradation of four ECs by activating the PMS with the ZSM-5-(C@Fe) are shown in FIG. 4.

TABLE 4

| | Removal | Removal | Removal | Removal |
|---|---|---|---|---|
| | rate % | rate % | rate % | rate % |
| Time | (Cipro- | (Tetrabromo- | (Sulfameth- | (Trichloro- |
| (min) | floxacin) | bisphenol A) | oxazole) | phenol) |
| 0 | 0 | 0 | 0 | 0 |
| 2 | 34.22 | 32.31 | 33.68 | 34.22 |
| 4 | 59.11 | 54.78 | 56.78 | 59.11 |
| 6 | 81.53 | 72.56 | 75.89 | 81.53 |
| 10 | 94.78 | 87.56 | 90.56 | 94.78 |
| 15 | 100 | 100 | 100 | 100 |
| 20 | 100 | 100 | 100 | 100 |
| 30 | 100 | 100 | 100 | 100 |

It can be seen from Table 4 that: at 30 minutes, good removal effects of multiple ECs degraded by catalytically activating the PMS with the ZSM-5-(C@Fe) are realized.

### Embodiment 5

In the embodiment, recycling of a degradation reaction of a tetrabromobisphenol A by catalytically activating a PMS with a ZSM-5-(C@Fe) was investigated.

(1) A preparation method of the ZSM-5-(C@Fe) was the same as the step (1) in the Embodiment 1.

(2) 0.036 mmol·L⁻¹ ciprofloxacin solution was prepared for later use.

(3) A conical flask was used as a reactor, 0.144 mmol of PMS and 100 mL of ciprofloxacin solution with a concentration of 0.036 mmol·L⁻¹ were added into a reactor 1, 0.4 g of ZSM-5-(C@Fe) was added into the reactor at the same time, the conical flask was put into a shaking table at 180 rpm for reaction at a room temperature (25° C.), and spot sampling analysis was carried out.

(4) After the step (3) was finished, the ZSM-5-(C@Fe) in a reactor 1 was recovered, the degradation reaction was continued, and conditions were the same as those in the (3).

(5) After the step (4) was finished, the ZSM-5-(C@Fe) in the reactor 1 was recovered, the degradation reaction was continued, and conditions were the same as those in the (3).

(6) After the step (5) was finished, the ZSM-5-(C@Fe) in the reactor 1 was recovered, the degradation reaction was continued, and conditions were the same as those in the (3).

(7) After the step (6) was finished, the ZSM-5-(C@Fe) in the reactor 1 was recovered, the degradation reaction was continued, and conditions were the same as those in the (3).

Removal rates of the ciprofloxacin obtained by five processes are shown in Table 5.

TABLE 5

| | | | Removal | Removal | Removal |
|---|---|---|---|---|---|
| | Removal | Removal | rate % | rate % | rate % |
| Time | rate % | rate % | (Three | (Four | (Five |
| (min) | (Once) | (Twice) | times) | times) | times) |
| 0 | 0 | 0 | 0 | 0 | 0 |
| 2 | 34.22 | 36.22 | 32.22 | 34.72 | 34.45 |
| 4 | 59.11 | 61.11 | 57.11 | 58.11 | 58.91 |
| 6 | 81.53 | 82.53 | 79.3 | 80.53 | 81.07 |
| 10 | 94.78 | 95.78 | 93.78 | 93.978 | 94.18 |
| 15 | 100 | 100 | 100 | 100 | 100 |
| 20 | 100 | 100 | 100 | 100 | 100 |
| Recovery | 99.87 | 99.65 | 99.72 | 99.68 | 99.57 |
| rate (%) | | | | | |

It can be seen from table 5 that: in a cyclic degradation experiment of degradation of the ciprofloxacin by catalytically activating the PMS with the ZSM-5-(C@Fe), it can be clearly found that with increase of cycle times, the removal rate of the ciprofloxacin is basically stable, and the catalyst may be almost completely recovered. Therefore, the ZSM-5-(C@Fe) may still catalytically activating the PMS effectively to degrade the ECs after many cycles.

The above embodiments are only the preferred embodiments of the present invention, which are only used to explain the present invention, and are not intended to limit the present invention. The changes, substitutions, modifications, and the like made by those skilled in the art without departing from the spirit of the present invention shall belong to the scope of protection of the present invention.

What is claimed is:

1. A preparation method of a millimeter-scale peroxymonosulfate activator ZSM-5-(C@Fe), comprising the following steps:
(1) preprocessing a ZSM-5 by a carboxylation method to obtain a ZSM-5-COOH;
(2) synthesizing a ferrous metal organic framework material by a thermal method to obtain a precursor Fe (II)-MOF-74;
(3) dispersing the ZSM-5-COOH in the step (1) and an ethyldiol methacrylate in an acetonitrile, and mixing evenly to obtain a mixed solution; and adding the precursor Fe(II)-MOF-74 in the step (2) into the mixed solution, carrying out a stirring reaction under an action of an initiator, filtering to obtain a precipitate, washing, and drying in vacuum to obtain ZSM-5-MOFs; and
(4) in a nitrogen atmosphere, heating the ZSM-5-MOFs in the step (3) to carry out high-temperature pyrolysis to obtain the millimeter-scale peroxymonosulfate activator ZSM-5-(C@Fe).

2. The preparation method of the millimeter-scale peroxymonosulfate activator ZSM-5-(C@Fe) according to claim 1, wherein a mass ratio of the ZSM-5-COOH to the precursor Fe(II)-MOF-74 in the step (3) is 10:1 to 10:2.

3. The preparation method of the millimeter-scale peroxymonosulfate activator ZSM-5-(C@Fe) according to claim 1, wherein a mass-volume ratio of the ZSM-5-COOH to the acetonitrile in the step (3) is (5 to 15):100 g/mL.

4. The preparation method of the millimeter-scale peroxymonosulfate activator ZSM-5-(C@Fe) according to claim 1, wherein a molar volume ratio of the ethyldiol methacrylate to the acetonitrile in the step (3) is (25 to 75):100 mmol/mL.

5. The preparation method of the millimeter-scale peroxymonosulfate activator ZSM-5-(C@Fe) according to claim 1, wherein the stirring reaction in the step (3) is carried out at 40° C. to 80° C. for 20 hours to 28 hours; and the initiator is azobisisobutyronitrile.

6. The preparation method of the millimeter-scale peroxymonosulfate activator ZSM-5-(C@Fe) according to claim 1, wherein the drying in vacuum in the step (3) is carried out at 50° C. to 80° C. for 10 hours to 12 hours.

7. The preparation method of the millimeter-scale peroxymonosulfate activator ZSM-5-(C@Fe) according to claim 1, wherein the high-temperature pyrolysis in the step (4) is carried out at 400° C. to 600° C. for 1 hour to 3 hours.

8. A millimeter-scale peroxymonosulfate activator ZSM-5-(C@Fe) prepared by the preparation method according to claim 1.

9. A method of applying the millimeter-scale peroxymonosulfate activator ZSM-5-(C@Fe) according to claim 8 in treating emerging contaminants (ECs) in wastewater, comprising the following steps:
adding the millimeter peroxymonosulfate activator ZSM-5-(C@Fe) and a peroxymonosulfate into the wastewater containing the ECs, and then performing a catalytic activation reaction in a shaking table to obtain the treated wastewater.

10. The method of applying the millimeter-scale peroxymonosulfate activator ZSM-5-(C@Fe) in treating the ECs in the wastewater according to claim 9, wherein a molar ratio of the peroxymonosulfate to the ECs in the wastewater is 10:1 to 50:1; an adding amount of the millimeter peroxymonosulfate activator ZSM-5-(C@Fe) is 1 g·L⁻¹ to 5 g·L⁻¹; the ECs are more than one of tetrabromobisphenol A, sulfamethoxazole, trichlorophenol, and ciprofloxacin; the shaking table has a rotating speed of 50 rpm to 200 rpm, and the catalytic activation reaction lasts for 10 minutes to 30 minutes.

11. A millimeter-scale peroxymonosulfate activator ZSM-5-(C@Fe) prepared by the preparation method according to claim 2.

12. A millimeter-scale peroxymonosulfate activator ZSM-5-(C@Fe) prepared by the preparation method according to claim 3.

13. A millimeter-scale peroxymonosulfate activator ZSM-5-(C@Fe) prepared by the preparation method according to claim 4.

14. A millimeter-scale peroxymonosulfate activator ZSM-5-(C@Fe) prepared by the preparation method according to claim 5.

15. A millimeter-scale peroxymonosulfate activator ZSM-5-(C@Fe) prepared by the preparation method according to claim 6.

16. A millimeter-scale peroxymonosulfate activator ZSM-5-(C@Fe) prepared by the preparation method according to claim 7.
